(19) United States
(12) Patent Application Publication
(10) Pub. No.: US 2006/0127863 A1
(43) Pub. Date: Jun. 15, 2006

(54) Educational blocks

(76) Inventor: Jean Avery, Spring Lake, NJ (US)

Correspondence Address: Kenneth F. Florek;Hedman & Costigan, P.C., 1185 Avenue of the Americas, New York, NY, 10036, US

(21) Appl. No.: 11/009,796

(22) Filed: Dec. 10, 2004

(51) Int. Cl. G09B 21/00

(52) U.S. Cl. 434/112

(57) ABSTRACT

An educational block having at least one block surface with at least one character thereon, the character having a tactile character surface in the shape of the character represented recessed below the block surface.

### FIELD OF THE INVENTION

The present invention relates to educational blocks for teaching students how to form numbers and letters. More particularly, the invention relates to an educational number/letter block which assists in teaching students the shapes of numbers and letters using sensory stimulation.

### BACKGROUND OF THE INVENTION

Educational number/letter blocks have been known for many years. These blocks have included alphanumeric characters painted or carved on the blocks for visual determination of the alphanumeric number/letter. Typically, these educational blocks have been formed in the shape of a cube, with six sides each having one number and/or letter character on each of the sides.

More recently, educational items have begun using sensory stimulation techniques to assist in learning. Number/letter blocks have included raised alphanumeric characters on one or more surfaces for a student to feel the edges of the alphanumeric character presented.

In another more recent development, sandpaper has also sometimes been adhered to the uppermost raised surface of the alphanumeric character for additional sensory stimulation.

Additionally, number/letter blocks have been formed in planar configurations, with only one side including an alphanumeric character, rather than cubes with six sides each including a character.

However, the number/letter blocks currently available for teaching students the alphanumeric characters do not provide the best sensory tools for teaching students how to learn and form the characters.

### SUMMARY OF THE INVENTION

The present invention is directed to an educational block for learning numbers and/or letters, comprising at least one block surface with at least one alphanumeric character thereon, the alphanumeric character having a tactile character surface in the shape of the character recessed below the block surface, such that the character surface provides a sensory stimulation to the student.

The block of the present invention may be formed in any configuration, including a cube with six sides, a substantially planar form with a character on one or two sides or any multisided form. Although more than one alphanumeric character my be incorporated onto one side of a block, it is preferred that only one character be placed on any one side of the block.

The depth of the recessed character surface need only be sufficient to provide a perceptible edge below the block surface wherein the student can move a finger along the edge of the character without the finger slipping off of the edge. In this regard, it has been determined that the recessed nature of the character allows for greater control of errors than the raised configuration of the prior art, since the student's finger is bounded by the edge of the recessed character.

Similarly, the texture of the character surface need not be any particular texture, but only sufficient to provide a surface that can be differentiated by the student upon touch. As such, any tactile surface that provides a sensory stimulation to the student would be acceptable.

The block can be made of any suitable material or materials, however, it is preferred that the block be made of molded plastic. In such an embodiment, the tactile surface can be molded directly onto the surface rather than using a separate material. Of course, if desired, the tactile surface can be sandpaper or a similar material adhered to the recessed character surface or a gritty material, such as sand, embedded into the recessed character surface.

The blocks of the present invention can be any suitable size, so long as the character is of sufficient size such that a student running a finger over the recessed edge of the character and onto the tactile character surface can sense the edge of the character and the texture of the character surface.

It is also preferred that the block of the present invention, especially when embodied in a planar form, have a hole therethrough so that like blocks can be strung together on a string, chain, chord or the like.

### BRIEF DESCRIPTION OF THE DRAWINGS

The drawings which are a part of the present application are intended to illustrate the present invention, without limiting the invention in any manner whatsoever, wherein:

FIG. 1 is a perspective view of a block of the present invention in a planar configuration.

FIG. 2 is a cross sectional view of the block of FIG. 1 through line A-A on FIG. 1.

FIG. 3 is a partial perspective view of a corner of a block with a loop for stringing blocks together.

### DETAILED DESCRIPTION OF THE PREFERRED EMBODIMENT

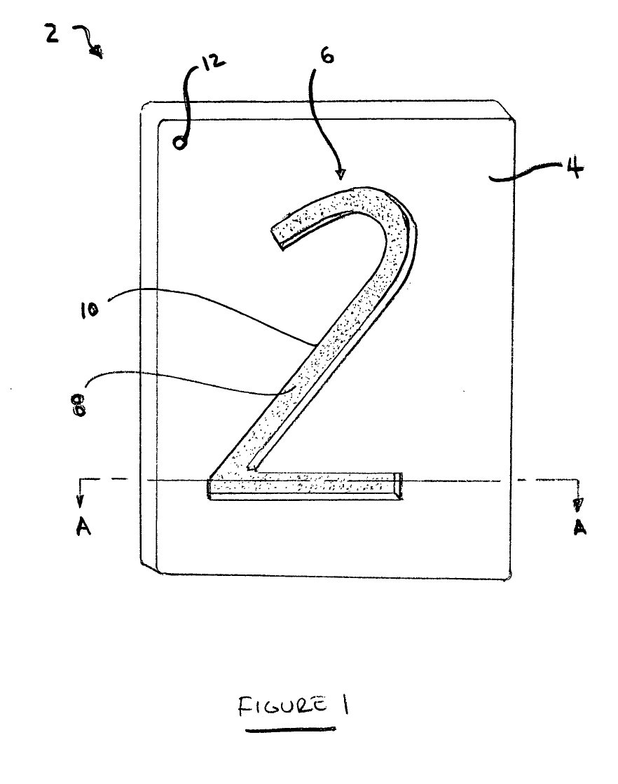

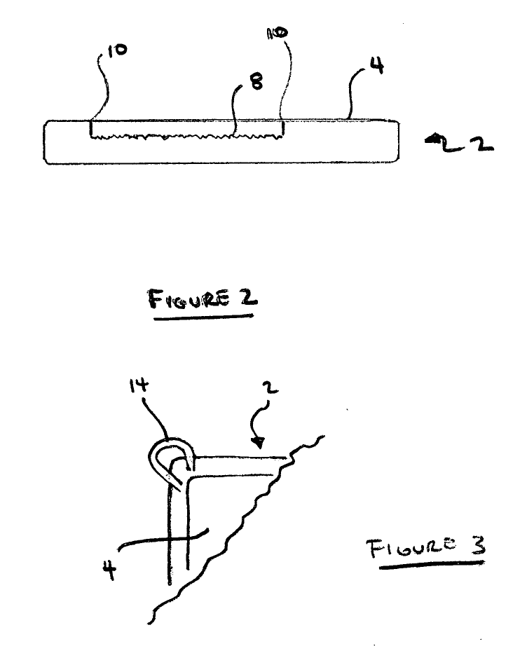

As shown in FIG. 1, the present invention comprises an educational block 2 having at least one block surface 4 with at least one alphanumeric character 6 thereon, the alphanumeric character 6 having a character surface 8 in the shape of the character 6 represented recessed below the block surface. The character surface 8 has a tactile nature, being made of a perceptively different material or having an abrasive, rough, coarse or uneven texture for sensory stimulation.

The block 2 can be in any suitable shape with any suitable number of sides having alphanumeric characters 6. For example, the block 2 can have six sides each with a character 6. Preferably, the block 2 is formed in a planar configuration with a character 6 on one side, although a block 2 formed in a planar configuration may have characters 6 on both sides.

The block 2 can be of any suitable size, provided that the character 6 is of sufficient size for the student to engage the recessed character surface 8 and sense the tactile nature of the character surface 8. The preferred block 2 shown in the Figures is formed in a planar configuration, and is from about 2 to about 3 inches wide and from about 4 to about 6 inches high. When a character 6 is formed on only one side of the planar block 2, the block 2 is preferably about ¼ to about ⅝ inch thick.

The character 6 itself preferably covers a majority of the block surface 4. The character surface 8 is sufficiently wide for the student to place a finger onto the character surface 8, to sense the texture of the character surface 8. The character surface 8 is also recessed a sufficient amount such that the student's finger is maintained within the edge 10 of the character 6 when moved along the edge 10 of the character 6. In its preferred embodiment, the character surface 8 is recessed from about 1/16 inch to about 3/16 inch below the block surface 4.

As set forth above, the tactile nature of the character surface 8 can be formed in any manner, including from a different material such as sandpaper adhered to the surface, a gritty material such as sand embedded onto the character surface 8 or a soft rubber contrasting a smooth, hard block surface 4. Preferably, however, the block 2 is made from a molded plastic with the character surface 8 having a texture molded thereon. In this regard, the texture can be formed in any pattern or randomly, so long as the student can perceive the texture.

The most preferred block 2 of the present invention is formed of a molded polymer, such as polyethylene, polypropylene, polyvinylchloride, polycarbonate, or a similar material. Preferably, the blocks 2 are colored and may have different colors for different categories of characters 6, e.g., vowels being colored differently from consonants, numbers colored differently from letters, etc.

The preferred block 2 has means for stringing multiple blocks 2 together. In the preferred planar configuration, each block 2 to be strung together preferably has a hole 12 in a corner of the block 2. The hole 12 can be of any suitable size, but is preferably from about ⅛ inch to about ¼ inch in diameter so that a string, chain, cord, ring or the like can pass through and hold the blocks 2 together.

In the planar or other configuration, such as a cube, the blocks 2 can have other means for stringing multiple blocks 2 together. For example, an eyelet 14, formed of metal, wire, string or the like can be formed to extend from a comer of the block 2, such that a string, chain, cord, ring or the like can be threaded through the eyelet 14 to string multiple blocks 2 together.

Of course, variations, modifications, or deviations to the above description may be or become known to persons skilled in the art in light of this description. All such variations, modifications, deviations and the like are intended to be part of the present invention, limited only by the following claims.

I claim:

1. An educational block comprising at least one block surface with at least one character thereon, the character having a tactile character surface recessed below the block surface.

2. The educational block of claim I wherein the block is formed in a planar configuration.

3. The educational block of claim 1 wherein the tactile character surface is recessed from about 1/16 inch to about 3/16 inch below the block surface.

4. The educational block of claim 1 wherein the block is formed of a molded plastic.

5. The educational block of claim 4 wherein the tactile character surface comprises a texture molded onto the character surface.

6. The educational block of claim 1 wherein the tactile character surface comprises a textured material adhered to the character surface.

7. The educational block of claim 6 wherein the textured material is sandpaper.

8. The educational block of claim 1 wherein the tactile character surface comprises a gritty material embedded into the character surface.

9. The educational block of claim 8 wherein the gritty material is sand.

10. The educational block of claim 1 further comprising an aperture for receiving a stringing element to string two or more blocks together.

11. The educational block of claim 10 where the aperture is formed directly through a portion of the block.

12. The educational block of claim 10 where the aperture is an eyelet extending from the block.

13. The educational block of claim 12 where the eyelet is formed from a wire embedded into the block.
